(19) United States
(12) Patent Application Publication
(10) Pub. No.: US 2024/0303301 A1
(43) Pub. Date: Sep. 12, 2024

(54) METHOD, SYSTEM AND COMPUTER-READABLE STORAGE MEDIUM FOR MANAGING COLLABORATIVE PRODUCT

(71) Applicant: Brian Zhongdong LIN, New Providence, NJ (US)

(72) Inventor: Brian Zhongdong LIN, New Providence, NJ (US)

(21) Appl. No.: 18/117,636

(22) Filed: Mar. 6, 2023

(51) Int. Cl. G06F 21/10; G06Q 10/10; G06Q 10/101

(52) U.S. Cl. CPC G06F 21/1075; G06Q 10/101; G06Q 10/103

(57) ABSTRACT

The disclosure is about hierarchically managing collaborative products in collaboration with a plurality of source owners respectively owning a plurality of source products. Transaction information is generated in association with collaborative product between source owners and a collaborative user. Sets of right information of inferior collaborative product are created based on right information of source products and transaction information. Right information reflects a right relationship between collaborative user and corresponding source owner. A hierarchical data structure of collaborative products and source produces can be further formed by executing at least N time steps of: generating N+1th transaction information in association with N+1th inferior collaborative product between an owner of Nth inferior collaborative product and a collaborative user of N+1th inferior collaborative product; creating a combination of right information of the N+1th inferior collaborative product based on right information of Nth inferior collaborative product and N+1th transaction information.

### BACKGROUND OF THE INVENTION

### 1. Field of the Invention

The present invention relates to management of a collaborative product, in particular to management of commercial and legal right of a collaborative product.

### 2. Description of Related Art

In a conventional system for collaboration, the work products are created within the development environment in order for the information tracking to take place. In reality, this type of collaborations is a very small fraction of the collaborated work. As the rights being tracked, the conventional system for collaboration concern only the work being performed within a single development environment and only the information for tracking process within the said environment.

### SUMMARY OF THE INVENTION

In one aspect of the present disclosure, a method for hierarchically managing collaborative products including at least one first inferior collaborative product in collaboration with a plurality of source owners respectively owning a plurality of source products, comprises: receiving at least one first collaboration request for the first inferior collaborative product originated from the source products; obtaining right information of the source products; generating first transaction information in association with the first inferior collaborative product between the source owners and a collaborative user of the first inferior collaborative product; creating a combination of a plurality of sets of right information of the first inferior collaborative product based on the right information of the source products and the first transaction information, wherein each set of the right information of the first inferior collaborative product reflects a right relationship between the collaborative user of the first inferior collaborative product and the corresponding one of the source owners; and storing the combination of the sets of the right information of the first inferior collaborative product and the first transaction information.

In some embodiments, the method further comprises: forming a hierarchical data structure of the collaborative products and the source produces by executing at least N time following steps of: receiving at least one N+1th collaboration request for at least one N+1th inferior collaborative product of the collaborative products originated from the Nth inferior collaborative product; obtaining right information of the Nth inferior collaborative product; generating N+1th transaction information in association with the N+1th inferior collaborative product between an owner of the Nth inferior collaborative product and a collaborative user of the N+1th inferior collaborative product; creating a combination of at least one set of right information of the N+1th inferior collaborative product based on the right information of the Nth inferior collaborative product and the N+1th transaction information, wherein each set of the right information of the N+1th inferior collaborative product reflects a right relationship between the collaborative user of the N+1th inferior collaborative product and the corresponding one of the owner of the Nth inferior collaborative product; and storing the combination of the at least one set of the right information of the N+1th inferior collaborative product and the N+1th transaction information; wherein N>=1, N is positive integer; wherein the right relationships between the source owners and the collaborative user of the N+1th inferior collaborative product are recorded in or traceable by the right information of the N+1th inferior collaborative product.

In another aspect of the present disclosure, a system for hierarchically managing collaborative products including at least one first inferior collaborative product in collaboration with a plurality of source owners respectively owning a plurality of source products, comprises: one or more processors; and one or more computer-readable storage media having stored thereon computer-readable instructions executable by the one or more processors to cause the system to perform operations comprising: receiving at least one first collaboration request for the first inferior collaborative product originated from the source products; obtaining right information of the source product; generating first transaction information in association with the first inferior collaborative product between the source owners and a collaborative user of the first inferior collaborative product; creating a combination of a plurality of sets of right information of the first inferior collaborative product based on the right information of the source products and the first transaction information, wherein each set of the right information of the first inferior collaborative product reflects a right relationship between the collaborative user of the first inferior collaborative product and the corresponding one of the source owners; and storing the combination of the sets of the right information of the first inferior collaborative product and the first transaction information.

In some embodiments, the system is caused to perform operations further comprising: forming a hierarchical data structure of the collaborative products and the source produces by executing at least N time following steps of: receiving at least one N+1th collaboration request for at least one N+1th inferior collaborative product of the collaborative products originated from the Nth inferior collaborative product; obtaining right information of the Nth inferior collaborative product; generating N+1th transaction information in association with the N+1th inferior collaborative product between an owner of the Nth inferior collaborative product and a collaborative user of the N+1th inferior collaborative product; creating a combination of at least one set of right information of the N+1th inferior collaborative product based on the right information of the Nth inferior collaborative product and the N+1th transaction information, wherein each set of the right information of the N+1th inferior collaborative product reflects a right relationship between the collaborative user of the N+1th inferior collaborative product and the corresponding one of the owner of the Nth inferior collaborative product; and storing the combination of the at least one set of the right information of the N+1th inferior collaborative product and the N+1th transaction information; wherein N>=1, N is positive integer; wherein the right relationships between the source owners and the collaborative user of the N+1th inferior collaborative product are recorded in or traceable by the right information of the N+1th inferior collaborative product.

In yet another aspect of the present disclosure, a non-transitory computer-readable storage medium has stored thereon computer-readable instructions for hierarchically managing collaborative products including at least one first inferior collaborative product in collaboration with a plurality of source owners respectively owning a plurality of source products. The computer-readable instructions are executable to cause a computer to perform operations comprising: receiving at least one first collaboration request for the first inferior collaborative product originated from the source products; obtaining right information of the source products; generating first transaction information in association with the first inferior collaborative product between the source owners and a collaborative user of the first inferior collaborative product; creating a combination of a plurality of sets of right information of the first inferior collaborative product based on the right information of the source products and the first transaction information, wherein each set of the right information of the first inferior collaborative product reflects a right relationship between the collaborative user of the first inferior collaborative product and the corresponding one of the source owners; and storing the combination of the sets of the right information of the first inferior collaborative product and the first transaction information

In some embodiments, the computer is caused to perform operations further comprising: forming a hierarchical data structure of the collaborative products and the source produces by executing at least N time following steps of: receiving at least one N+1th collaboration request for at least one N+1th inferior collaborative product of the collaborative products originated from the Nth inferior collaborative product; obtaining right information of the Nth inferior collaborative product; generating N+1th transaction information in association with the N+1th inferior collaborative product between an owner of the Nth inferior collaborative product and a collaborative user of the N+1th inferior collaborative product; creating a combination of at least one set of right information of the N+1th inferior collaborative product based on the right information of the Nth inferior collaborative product and the N+1th transaction information, wherein each set of the right information of the N+1th inferior collaborative product reflects a right relationship between the collaborative user of the N+1th inferior collaborative product and the corresponding one of the owner of the Nth inferior collaborative product; and storing the combination of the at least one set of the right information of the N+1th inferior collaborative product and the N+1th transaction information; wherein N>=1, N is positive integer; wherein the right relationships between the source owners and the collaborative user of the N+1th inferior collaborative product are recorded in or traceable by the right information of the N+1th inferior collaborative product.

In some embodiments, the hierarchical data structure presents hierarchical relationships of the collaborative products and the source produces in multiple layers. In the hierarchical data structure, the relationship between superior product and inferior product include one-to-one, multiple-to-one and one-to-multiple. In some relationships, the source product is superior product and the associated collaborative product is inferior product. In some relationships, the superior collaborative product is superior product and the associated inferior collaborative product is inferior product. In some relationships, the source product and the superior collaborative product are superior products and the associated inferior collaborative product is inferior product. Thus, one collaborative product may be derived from one or more source products and/or other one or more collaborative products. In the hierarchical data structure, the combination of the sets of the right information and the transaction information reflect the relationships between superior products and inferior products in multiple layers. The hierarchical data structure is easily expandable and compatible.

The method, system and computer-readable instructions for hierarchically managing collaborative products are compatible with the current existing platform or system, for example entertainment or content platform, and help the platform to provide services of hierarchical product management in convenient manners, which may be a burden for the platform to build or provide with. With the hierarchical product management, it is convenient for the platform or the owner of the product to manage the owner's product and his associated collaborative products in multiple associated layers.

### BRIEF DESCRIPTION OF THE DRAWINGS

In order to sufficiently understand the essence, advantages and the preferred embodiments of the present disclosure, the following detailed description will be more clearly understood by referring to the accompanying drawings.

FIG. 1 depicts a block diagram showing an example of commercial software collaboration according to some embodiments.

FIG. 2 depicts a block diagram showing an example of video game development collaboration according to some embodiments.

FIG. 3 depicts a block diagram showing an example of short video development collaboration according to some embodiments.

FIGS. 4A and 4B depict a flow chart of managing a collaborative product of a collaborative user in collaboration with a source owner owning a source product according to some embodiments.

FIG. 5 depicts a block diagram showing an example of a system and an external device according to some embodiments.

FIG. 6 depicts a block diagram showing a right transaction in the system according to some embodiments.

FIG. 7 depicts a tree structure of the hierarchical collaborative products according to some embodiments.

FIG. 8 depicts an integration of the system with other platforms according to some embodiments.

FIG. 9 depicts a flow chart for application of entitlement distribution according to some embodiments.

FIG. 10 depicts a flow chart for application of voting mechanism according to some embodiments.

FIG. 11 depicts a flow chart for application of obtaining certified documents for legal purpose according to some embodiments.

FIG. 12 depicts a block diagram showing metadata for right and transaction according to some embodiments.

FIG. 13 depicts a block diagram showing an example of a system implemented with blockchain and metadata database according to some embodiments.

FIG. 14 depicts a flow chart for application of updating or nullifying a record according to some embodiments.

FIG. 15 depicts a block diagram showing an example of a system implemented with relationship database according to some embodiments.

FIG. 16 depicts a flow chart of an operating example of the system according to some embodiments.

FIG. 17 depicts a flow chart of another operating example of the system according to some embodiments.

FIG. 18 depicts a block diagram showing an example of entitlement collection and distribution with smart contract according to some embodiments.

FIG. 19 depicts a block diagram showing an example of voting mechanism with smart contract according to some embodiments.

FIG. 20 depicts a block diagram showing an example of legal document collection with smart contract according to some embodiments.

FIG. 21 depicts a flow chart of communication originated from content platform according to some embodiments.

### DETAILED DESCRIPTION OF THE INVENTION

The following description shows the preferred embodiments of the present disclosure. The present disclosure is described below by referring to the embodiments and the figures. Thus, the present disclosure is not intended to be limited to the embodiments shown, but is to be accorded the principles disclosed herein. Furthermore, that various modifications or changes in light thereof will be suggested to persons skilled in the art and are to be included within the spirit and purview of this application and scope of the appended claims.

More and more products, such as software, hardware, or video game products, are created through collaborations among multiple parties within product development community as well as within user created entertainment platforms for making short videos, indie music, group generated stories/arts, etc. As our society embraces remote work, individual contributions and metaverse as a co-creation environment, the collaborated creative work done by aggregations of unrelated creators will become a significant part of global product output. Unlike the past company level IP collaborations which are often among parties with substantial resources, these collaborations involve individuals with quite limited legal or commercial knowledge, and the values of IP involved are often of lower values, such as in the orders of a few dollars to a few thousand dollars. Additionally, the sale numbers are often unknown ahead of creation time (a few hundred to a few millions). On top of these commercial hurdles, a single product creation might involve multiple parties in multiple layers, and involve different development tools.

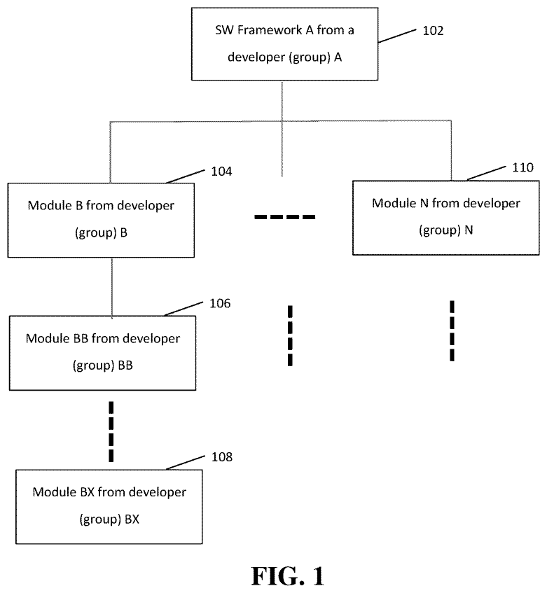

FIGS. 1-3 show some examples of collaboration. FIG. 1 depicts a block diagram showing an example of commercial software collaboration. In FIG. 1, a software framework A is developed from a developer (group) A (102). A developer (group) B develops a module B which is originated from the software framework A in collaboration (104). Similarly, a developer (group) BB develops a module BB which is originated from the module B in collaboration (106). Namely, a developer (group) N develops a child module N which is originated from its parent or source software framework A in collaboration (108), and a developer (group) BX develops a child module BX which is originated from its parent or source module in collaboration (110).

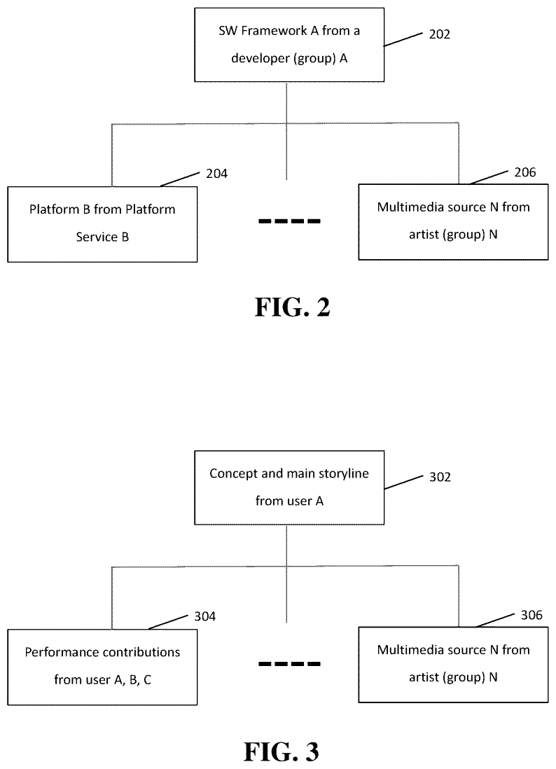

FIG. 2 depicts a block diagram showing an example of video game development collaboration. In FIG. 2, a software framework A is developed from a developer (group) A (202). A platform B which is originated from the software framework A in collaboration is established by the platform service B (204). A multimedia source N which is originated from the software framework A in collaboration is provided from an artist (group) N (206).

FIG. 3 depicts a block diagram showing an example of short video development collaboration. In FIG. 3, concept and main storyline is provided from a user A (302). Performance contributions which are originated from the concept and main storyline in collaboration are made by users A, B, and C (304). A multimedia source N which is originated from the concept and main storyline in collaboration is provided from an artist (group) N (306).

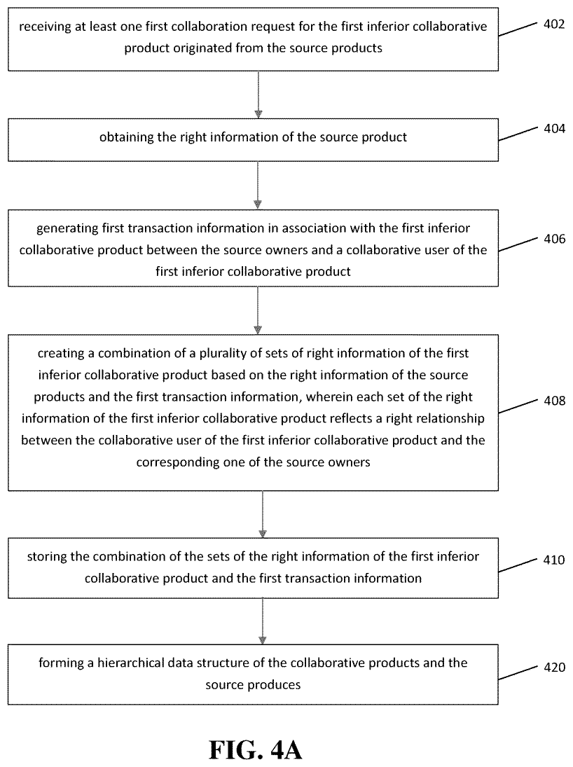

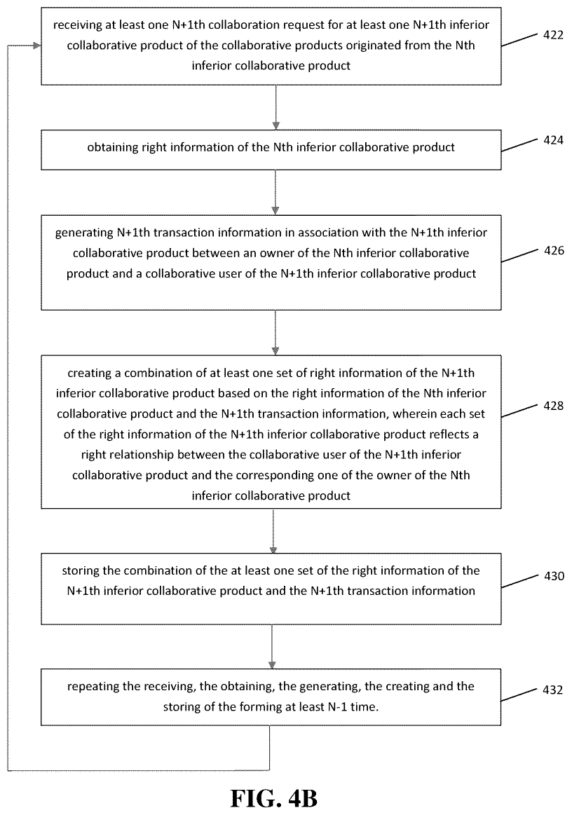

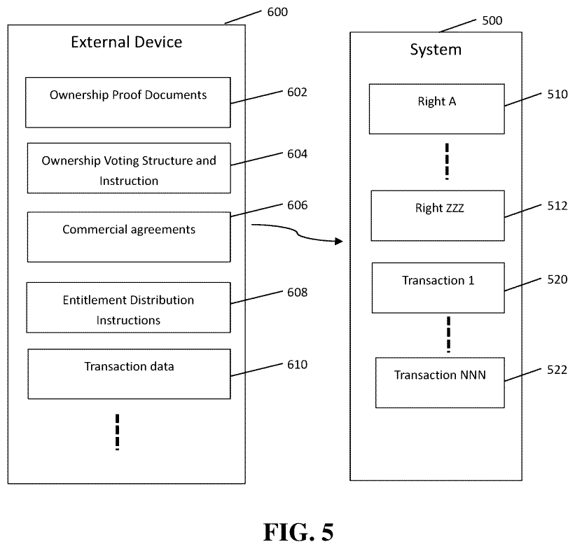

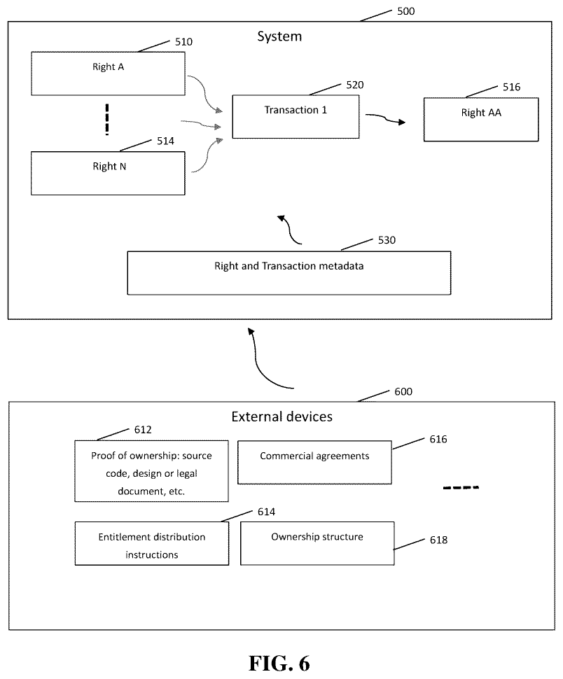

FIG. 4 depicts a flow chart of a method 400 for managing a collaborative product of a collaborative user in collaboration with a source owner owning a source product according to some embodiments. FIG. 5 depicts a block diagram showing an example of a system and an external device according to some embodiments. FIG. 6 depicts a block diagram showing a right transaction in the system according to some embodiments. The method 400 can be implemented by the system 500 in FIGS. 5-6.

According to some embodiments, the method 400 or the system 500 can be utilized for the application to protect the rights and the right transactions of the collaborated work products. The method 400 or the system 500 can relate to the commercial and legal right and transaction management of collaborated commercial product development, collaborated video game development, metaverse collaborated project development and other collaborated creative product development such as music, stories, video, stories, etc.

According to some embodiments, the method 400 or the system 500 can be concerned with the rights, right transactions of product collaborations, and the resulting new rights of collaborated product rather than only rights of individual work. The method 400 or the system 500 can manage the complex hierarchy of rights and transactions before, during and after integrations to prevent potential legal disputes. The method 400 or the system 500 can be provided for custodian depository system and marketplace for managing commercial and legal rights of products or product groups.

In FIGS. 4A and 4B, collaborative products include at least one first inferior collaborative product in collaboration with a plurality of source owners respectively owning a plurality of source products. In FIG. 4A, the method (400) comprises the steps of: receiving at least one first collaboration request for the first inferior collaborative product originated from the source products (402); obtaining the right information of the source product (404); generating first transaction information in association with the first inferior collaborative product between the source owners and a collaborative user of the first inferior collaborative product (406); creating a combination of a plurality of sets of right information of the first inferior collaborative product based on the right information of the source products and the first transaction information, wherein each set of the right information of the first inferior collaborative product reflects a right relationship between the collaborative user of the first inferior collaborative product and the corresponding one of the source owners (408); storing the combination of the sets of the right information of the first inferior collaborative product and the first transaction information (410); and forming a hierarchical data structure of the collaborative products and the source produces (420). In FIG. 4B, the forming (420) comprises executing at least N time following steps of: receiving at least one N+1th collaboration request for at least one N+1th inferior collaborative product of the collaborative products originated from the Nth inferior collaborative product (422); obtaining right information of the Nth inferior collaborative product (424); generating N+1th transaction information in association with the N+1th inferior collaborative product between an owner of the Nth inferior collaborative product and a collaborative user of the N+1th inferior collaborative product (426); creating a combination of at least one set of right information of the N+1th inferior collaborative product based on the right information of the Nth inferior collaborative product and the N+1th transaction information, wherein each set of the right information of the N+1th inferior collaborative product reflects a right relationship between the collaborative user of the N+1th inferior collaborative product and the corresponding one of the owner of the Nth inferior collaborative product (428); storing the combination of the at least one set of the right information of the N+1th inferior collaborative product and the N+1th transaction information (430); and repeating the receiving, the obtaining, the generating, the creating and the storing of the forming at least N−1 time (432). N>=1, N is positive integer. The right relationships between the source owners and the collaborative user of the N+1th inferior collaborative product are recorded in or traceable by the right information of the N+1th inferior collaborative product.

The collaborative product is, but not limited to, at least one of source code, executable software module, hardware design, electronic design, mechanical design, multimedia creative work (music, video, images, digital arts, etc.), story, book, metaverse virtual goods, etc.

The source product is, but not limited to, at least one of source code, executable software module, hardware design, electronic design, mechanical design, multimedia creative work (music, video, images, digital arts, etc.), story, book, metaverse virtual goods, etc. The source product or called the parent product is the origin of the collaborative product. The source product and the collaborative product can be the same type of product or different type of product. Each product is of a clear function, value and ownership.

The collaboration request is intended for a new product collaboration or represents a product of collaboration. The product of collaboration may be an existing collaborative product. The collaborative product can be either intended for product collaborations or is a finished product of such collaboration(s).

According to some embodiments, a user may play a role of the source owner or a role of the collaborative user of the method 400 or the system 500. According to some embodiments, a user may play a role of both the owner (e.g. source owner or the owner of the parent collaborative product) and a role of the collaborative user of the method 400 or the system 500. For example, one of the collaborative users is one of the source owners. The user is a member of a collaborated development community who likely has one or more of the following use cases:
The user owns one or more creative products such as source code, executable software module, hardware design, electronic design, mechanical design, multimedia creative work (music, video, images, digital arts, etc.), story, book, metaverse virtual goods, etc. The user would like to offer the products as collaborative parts of bigger projects in return for financial rewards. Such products are often digital and require partial or full disclosures before commercial transactions can be processed.
The user has a skillset that allows the user to offer his/her services for collaborative creations of a project, while protecting his/her commercial/legal rights to the part(s) created by the user.
The user has projects which require additional functions/parts that can be obtained by buying existing products or by commissioning such products.

The right information of the collaborative product and the right information of the source product (e.g., the right information 510, 512) describe commercial and legal property, and the commercial and legal property includes at least one of voting, ownership structure, entitlement allocation, proof of right ownership, commercial and/or legal transaction history of right, and right limitation. For example, the proof of right ownership includes source codes, design or legal documents, original images/music/video etc. For example, the commercial and/or legal transaction history of the right includes contractual agreements of past collaborations. The right information of the collaborative product is in associated with commercial and legal rights of the source owner and the collaborative user involved in the collaboration of the source owner and the collaborative user for the collaborative product. Each right may represent its product at a varied stage of development.

According to some embodiments, each right information 510, 512 in the system 500 in FIG. 5 is recorded with a unique ID and represents right including certain commercial and legal properties. Stakeholders or agents of stakeholders of the right are required to provide the necessary information to the system 500 for rights to be created. For example, the stakeholder or agent of stakeholder of the right (e.g., the source owner) can operate the external device 600 to upload the necessary information to the system 500. The necessary information includes at least one of ownership proof documents (602), ownership voting structure and instruction (604), commercial agreements (606), entitlement distribution instructions (608), and transaction data (610).

According to some embodiments, system 500 may include one or more processors and one or more computer-readable storage media having stored thereon computer-readable instructions executable by the one or more processors to cause the system 500 to perform operations of the method 400. The one or more computer-readable storage media may include a non-transitory computer-readable storage medium having stored thereon computer-readable instructions. The external device 600 may include one or more computing devices and have a connection with the system 500 through network.

The transaction information 520, 522 includes legal and supporting document regarding product collaboration, and the document includes at least one of commercial contract, agreed payment, future entitlement collection and distribution method, voting/ownership structure agreements, and void condition and limitation.

According to some embodiments, in FIG. 6, when a collaboration occurs, the right of the associated product represented by right information 510, 514 undertakes a right transaction represented by the transaction information 520, and new right information 516 is created by the system 500, which represents a new right of the collaborated product. A successful collaboration is recorded in the system 500 as a transaction (e.g. 520) of two or more rights (e.g. 510, 514), resulting in a successful transaction (e.g. 520) and a new right (e.g. 516). The transaction information 520 or 522 is recorded in the system 500 with an ID and represents a transaction including legal and supporting documents regarding the product collaboration and the references to all the products being collaborated. This process can be repeated unlimitedly to further create the additional rights, as long as it passes an integrity checks such as to prevent double inclusions or circular inclusions.

The information stored in the system 500 associated with the product includes, but not limited to: information that can collectively demonstrate a legal ownership such as creative contents or references to the contents (source codes, design documents, music scores, book excerpts, video clips) and/or legal documentations of the ownership, entitlement allocation methods, legal and voting ownership structures, etc.

The system 500 in FIG. 6 then records both the transaction information 520 and the new right information 516. The right and transaction information is stored in a way which provides security protections as well as transparent and efficient accesses by permissible users. The right holders of involved source products are required to provide all necessary information for the transaction and the new right of the new collaborative product. The necessary information includes proof of ownership 612, entitlement distribution instructions 614, commercial agreements 616, or ownership structure 618, etc. The proof of ownership includes source code, design or legal document, etc. The resulting right can be further collaborated with other rights using new transaction. Further, right and transaction metadata 530 may be generated in some embodiments.

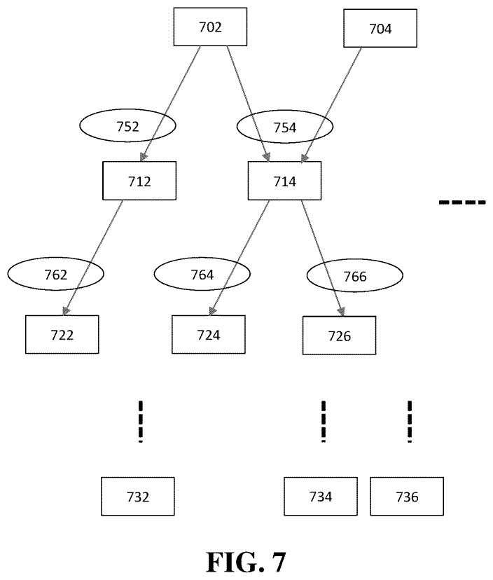

FIG. 7 depicts a tree structure 700 of the hierarchical collaborative products according to some embodiments. In FIG. 7, each of nodes 702, 704, 712, 714, 722, 724, 726, 732, 734, 736 represents right information of a product. The role of the product may be the source product or the collaborative product depending on the collaboration in branch. Each of blocks 752, 754, 762, 764, 766 represents transaction information of collaboration. In one branch of the tree structure 700, the parent or superior node represents the source product and its right information, the child or the inferior node represents the collaborative product and its right information. The transaction block on the branch between superior and inferior nodes represents the transaction information about the collaborative product of the inferior node from the source product of the superior node.

The nodes 702 and 704 represent the source products. The nodes 712 and 714 represent the first inferior collaborative products. The nodes 722, 724 and 726 represent the N+1th inferior collaborative products where Nis 1. The nodes 732, 734 and 736 represent the N+1th inferior collaborative products where N is larger than 1. In the hierarchical data structure 700, a node 702 of one of the source products is a parent node having multiple child nodes 712, 714 of the first inferior collaborative products. A node of one of the Nth inferior collaborative product is a parent node having multiple child nodes of the N+1th inferior collaborative products. For example, when N is 1, a node 714 of one of the first inferior collaborative product have multiple child nodes 724, 726 of the second inferior collaborative products.

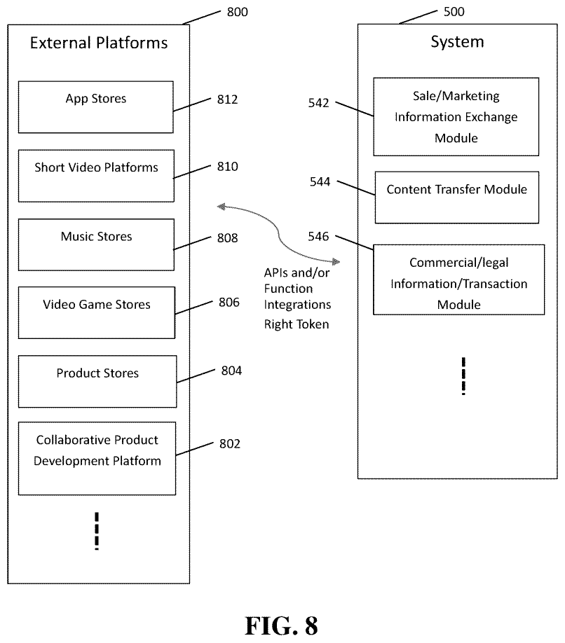

FIG. 8 depicts an integration of the system with other platforms according to some embodiments. The method 400 or the system 500 can be integrated with other product development/sale/display platforms which greatly enhance the usability of the product protection method or system in low cost ways. According to some embodiments, the method 400 or the system 500 can help the user, e.g. the creators of the products on the external platforms 800, to know the potential risk of infringements as most individual contributions have to be fully disclosed for integrations. The method 400 or the system 500 can also help the user, e.g. the creators of the products on the external platforms 800, to support required operations of the collaborative creations such as entitlement collection and distribution, voting mechanism, and legal dispute preparations which are often done in ad-hoc manners as legal and custodian service costs are beyond the means of the creators. As these products are displayed or developed in the external platforms 800 such as collaborative product development platforms 802, product stores 804, video game stores 806, music stores 808, short video platforms 810 or app stores 812, or game/story stores, etc., the system 500 can provide seamless integrations in functions such as sale/marketing information exchanges by module 542, content transfers by module 544, commercial/legal information/transaction by module 546, or sale revenue collections, etc. with the external platforms 800 through APIs or cross-platform function integrations. Thus, the creators can focus more on the creation processes.

Additionally, the method 400 or the system 500 can integrate with other product development/sale/display platforms for seamless product sale/marketing/product information exchanges and commercial/legal transactions such as sale, revenue collection, contracts, copyright inquiries, etc. by using a system generated token which contains specific right information such as right ID and operation instructions.

According to some embodiments, the method 400 or the system 500 may only manage the rights of the collaborated work by tracking the rights of individual or collaborated work and the right transactions during collaborations. The system 500 does not store the source product and the collaborative product on its storage medium. The storing (410) of the method 400 comprises: storing the right information of the collaborative product and the transaction information without storing a product content of the collaborative product.

The development work and the contractual agreements can happen outside of the main framework of the system 500. The system 500 relies on the parties involved to provide proof of rights (e.g. ownership documents) and right transactions (e.g. contractual agreements) for the information tracking.

According to some embodiments, the method 400 further comprises the steps of: accessing right information of at least associated one of the collaborative products by traveling associated nodes of the hierarchical data structure. The hierarchical data structure may be a linked tree structure of the collaborative products. As such, the method 400 or the system 500 can provide additional functions such as sale of right/product, entitlement collection and distributions, voting mechanism and collection or generation of relevant legal documents within the hierarchical data structure of the right and transaction information. These functions can be implemented as automated functions or as manual processes based on the information provided by the user. Permissible users can access the right information after security verifications by the system 500. In one example, if starting from the node 702 in FIG. 7, the traveling may include the inferior nodes 712, 714, 724, 726, . . . of the node 702. In one example, if starting from the node 724 in FIG. 7, the traveling may include the parent nodes 712, 702, 704. In one example, if starting from the node 714 in FIG. 7, the traveling may include both the parent nodes 702, 704 and inferior node 724.

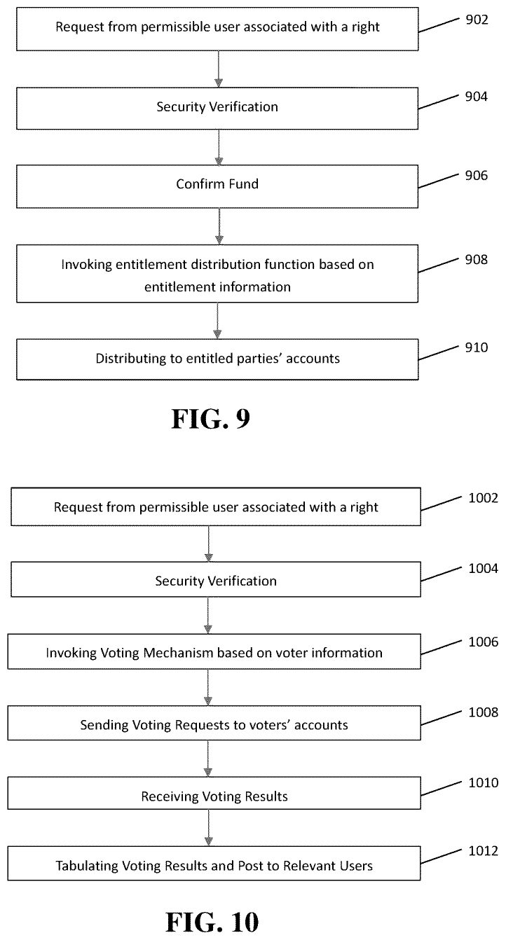

FIG. 9 depicts a flow chart for application of entitlement distribution according to some embodiments. In FIG. 9, the method 900 further comprises the steps of: receiving a request from a permissible user associated with a right (902); making security verification (904); confirming fund (906); invoking entitlement distribution based on entitlement information recorded in the right information of the hierarchical collaborative products resulting from accessing right information of at least associated one of the collaborative products by traveling associated nodes of the hierarchical data structure (908); and distributing entitlement to entitled parties' accounts according to the entitlement distribution (910). For example, assuming the permissible user owns a source product represented by the node 702 in FIG. 7, the entitlement distribution includes its inferior nodes 712, 714, 722, 724, 726 . . . etc. The entitlement information of these nodes is gathered by traveling the associated nodes of the hierarchical data structure starting from the node 702. Thus, the total benefits from the source product and its derivative collaborative products are counted according to the gathered entitlement information. In another example, assuming the permissible user owns a collaborative product represented by the node 714 in FIG. 7, the entitlement distribution includes its inferior nodes 724, 726 . . . etc. The entitlement information of these nodes is gathered by traveling the associated nodes of the hierarchical data structure starting from the node 714. Thus, the total benefits from this collaborative product and its derivative collaborative products are counted according to the gathered entitlement information. The above two examples illustrate traveling inferior nodes. In some embodiments, traveling superior nodes can be implemented. For example, assuming the permissible user owns a collaborative product represented by the node 724 in FIG. 7, the entitlement distribution includes its superior nodes 714, 702, 704. The entitlement information of these nodes is gathered by traveling the associated nodes of the hierarchical data structure starting from the node 724. Thus, the beneficiaries and their profits from this collaborative product are counted according to the gathered entitlement information.

FIG. 10 depicts a flow chart for application of voting mechanism according to some embodiments. In FIG. 10, the method 1000 further comprises the steps of: receiving a request from a permissible user associated with a right (1002); making security verification (1004); invoking voting mechanism based on voter information recorded in the right information of the hierarchical collaborative products resulting from accessing right information of at least associated one of the collaborative products by traveling associated nodes of the hierarchical data structure (1006); sending voting requests to voters' accounts according to the voting mechanism (1008); receiving voting results (1010); and tabulating the voting results and posting to relevant users (1012). For example, assuming the permissible user owns a source product represented by the node 702 in FIG. 7, its inferior nodes 712, 714, 722, 724, 726 . . . etc. are associated nodes. The voter information of these nodes is gathered by traveling the associated nodes of the hierarchical data structure starting from the node 702. Thus, the voters from the source product and its derivative collaborative products are then counted according to the voter information of these nodes. In another example, assuming the permissible user owns a collaborative product represented by the node 714 in FIG. 7, its inferior nodes 724, 726 . . . etc. are associated nodes. The voter information of these nodes is gathered by traveling the associated nodes of the hierarchical data structure starting from the node 714. Thus, the voters from this collaborative product and its derivative collaborative products are then counted according to the locations of these nodes. The above two examples illustrate traveling inferior nodes. In some embodiments, traveling superior nodes can be implemented. For example, assuming the permissible user owns a collaborative product represented by the node 724 in FIG. 7, its superior nodes 714, 702, 704 are associated nodes. The voter information of these nodes is gathered by traveling the associated nodes of the hierarchical data structure starting from the node 724. Thus, the voters from this collaborative product and its superior collaborative products are then counted according to the locations of these nodes. In some embodiments, traveling both superior and inferior nodes can be implemented. For example, assuming the permissible user owns a collaborative product represented by the node 714 in FIG. 7, its superior nodes 702, 704 and its inferior node 724 are associated nodes. The voter information of these nodes is gathered by traveling the associated nodes of the hierarchical data structure starting from the node 714. Thus, the voters from this collaborative product and its superior and inferior products are then counted according to the locations of these nodes.

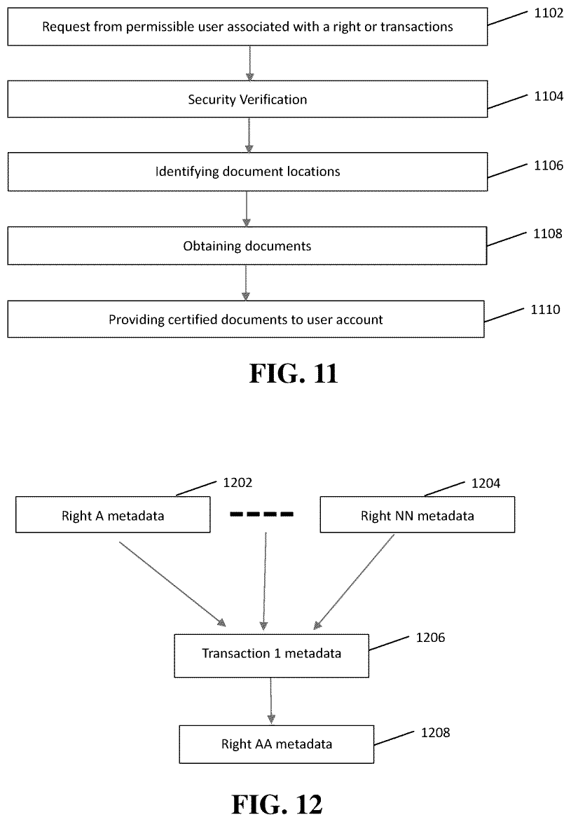

FIG. 11 depicts a flow chart for application of obtaining certified documents for legal purpose according to some embodiments. In FIG. 11, the method 1100 further comprises the steps of: receiving request from a permissible user associated with a right or transactions (1102); making security verification (1104); identifying locations of legal documents according to the right information of the hierarchical collaborative products resulting from accessing right information of at least associated one of the collaborative products by traveling associated nodes of the hierarchical data structure (1006); collecting the legal documents by obtaining from the locations (1008); and providing the legal documents to a user account (1110). For example, assuming the permissible user owns a source product represented by the node 702 in FIG. 7, its inferior nodes 712, 714, 722, 724, 726 . . . etc. are associated nodes. The locations of legal documents of these nodes are identified by traveling the associated nodes of the hierarchical data structure starting from the node 702. Thus, the associated legal documents from the source product and its derivative collaborative products are then collected according to the locations of these nodes. In another example, assuming the permissible user owns a collaborative product represented by the node 714 in FIG. 7, its inferior nodes 724, 726 . . . etc. are associated nodes. The locations of legal documents of these nodes are identified by traveling the associated nodes of the hierarchical data structure starting from the node 714. Thus, the associated legal documents from this collaborative product and its derivative collaborative products are then collected according to the locations of these nodes. The above two examples illustrate traveling inferior nodes. In some embodiments, traveling superior nodes can be implemented. For example, assuming the permissible user owns a collaborative product represented by the node 724 in FIG. 7, its superior nodes 714, 702, 704 are associated nodes. The locations of legal documents of these nodes are identified by traveling the associated nodes of the hierarchical data structure starting from the node 724. Thus, the associated legal documents from this collaborative product and its superior collaborative products are then collected according to the locations of these nodes. In some embodiments, traveling both superior and inferior nodes can be implemented. For example, assuming the permissible user owns a collaborative product represented by the node 714 in FIG. 7, its superior nodes 702, 704 and its inferior node 724 are associated nodes. The locations of legal documents of these nodes are identified by traveling the associated nodes of the hierarchical data structure starting from the node 714. Thus, the associated legal documents from this collaborative product and its superior and inferior products are then collected according to the locations of these nodes.

In FIGS. 9-11, the steps may be executed manually (an operator going through the information to perform the operations) or by a computerized process which involves automatically collecting information from the right structure and performing operations without human intervention.

According to some embodiments, the method or the system can therefore cover a majority of the current collaborated work practice and is used in a substantial different field of applications, i.e., not as a part of development environment but as an independent right tracking commerce and legal system. Further, the method or the system also help: protection of the commercial and legal rights of the parties involved in product collaborations; more complicated commercial agreements such as future payments on product sales or royalty agreements. The method or the system can provide functions such as entitlement collection and distribution, voting mechanism and legal records collections. The method or the system can efficiently hold publicly documented and legally provable evidences of the products, as well as managing any associated commercial and legal transactions of these products. The operations are in a secured, low-cost, efficient and transparent way.

FIG. 12 depicts a block diagram showing metadata for right information and transaction information according to some embodiments. According to some embodiments, the method 1200 further comprises the steps of: creating metadata 1206, 1208 to be associated with the right information of the collaborative product or the transaction information; and storing the metadata 1206, 1208 in a relationship database system. The metadata 1202, 1204, 1206, 1208 for management purposes may include at least one of name, keyword, abstract, demo or full content of the product, ownership structure, entitlement collection and distribution method, marketing and sale information (to be showed to buyers), transaction history, and reference/link to other right of other source or collaborative product. The metadata 1202, 1204, 1206, 1208 are used to manage the right or transaction. The metadata 1202, 1204, 1206, 1208 are used for keyword search, technical and sale information display to intended collaborators, voting, entitlement collection and distribution, or collection of reference commercial and legal data for a commercial or legal event (e.g. sales, disputes, etc.). The metadata 1202, 1204, 1206, 1208 are searchable data in the relationship database system.

In FIG. 12, metadata 1202, 1204, 1208 associated with the rights and metadata 1206 associated with the transaction are stored in a secured storage medium as hierarchal data structures in a relationship database provided by the system 500, implemented for efficient references and information processing. When each right information or transaction information is created, a set of metadata which contains information is stored in the database as searchable and sortable fashions using known methods. The hierarchical structures of rights being combined and resulting right are recorded as well (e.g. a linked tree data structure).

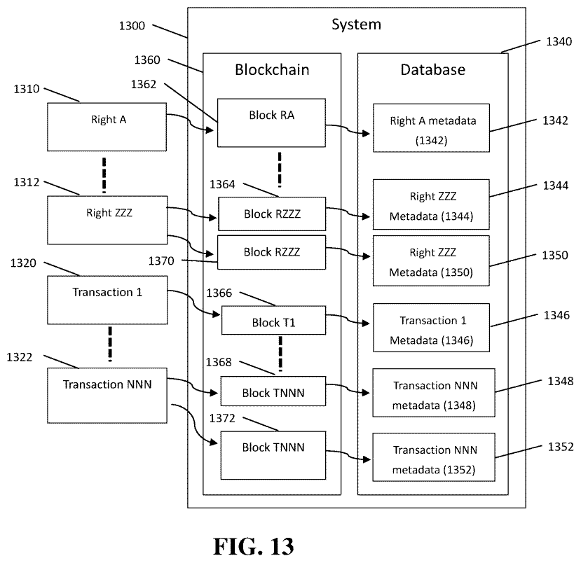

FIG. 13 depicts a block diagram showing an example of a system implemented with blockchain and metadata database according to some embodiments. Right information and transaction information are nonfungible blocks in a blockchain created by the system 1300 using information provided by the rightholders. Such a blockchain is maintained by the system 500 and its partners for secure and transparent storages. Such system can be built on top of current block chain platform such as Ethereum. Metadata associated with right or transaction are searchable data in a relationship database system (e.g. SQL) with each metadata object linked to related metadata objects in an efficient design such as encrypted linked lists. The method or the system 1300 provides multiple implementations using a combination of blockchains and relationship database for a secured, transparent, and efficient management. In the method or the system 1300, the storing (410) comprises the steps of: creating non-fungible blocks 1362, 1364, 1366, 1368 in a blockchain 1360; and embedding the right information 1310, 1312 of the collaborative product and the transaction information 1320, 1322 into the non-fungible blocks 1362, 1364, 1366, 1368. The method or the system 1300 further comprises the steps of: creating metadata 1342, 1344, 1346, 1348 to be associated with the right information 1310, 1312 of the collaborative product and the transaction information 1320, 1322; and updating the right information 1310, 1312 of the collaborative product and the transaction information 1320, 1322. The updating comprises the steps of: creating new non-fungible blocks 1370, 1372 in the blockchain 1360; embedding new right information 1312 of the collaborative product and new transaction information 1322 into the new non-fungible blocks 1370, 1372; marking the metadata 1344, 1348 associated with the right information of the collaborative product and the transaction information as obsolete; and creating metadata 1350, 1352 to be associated with the new right information 1312 of the collaborative product and the new transaction information 1322.

According to some embodiments, each right information or transaction information is implemented as a block in a depository blockchain (such as one built on the Ethereum platform) created by the system on its owners' behaves based on known methods (similar to a NFT market implementation). When creating a right or a transaction, a user is provided with a user interface which allows him/her to embed right/transaction information (as described above) into a token. A size limit is imposed on the token, therefore certain large size information might be required to be represented as URLs rather than as embedded contents (known method). User should also identify the permissible parties for the information viewing (known method) associated with each sections of the embedded information (contents, commercial/legal agreements, other legal documents, ownership structures, entitlement structures, summary information for browsing, sale/marketing information, etc.). Once this process is completed, user requests the system to create a token on the blockchain on his/her behavior. Once a token is created, it can not be updated or deleted (non-fungible). Any update to right or transaction needs to be done through the creation of another token inserted chronically after the prior one, an obsolete label will be applied to the prior one even though it is not removed in the system. This manner provides the better security and transparency but with higher costs and computing resources.

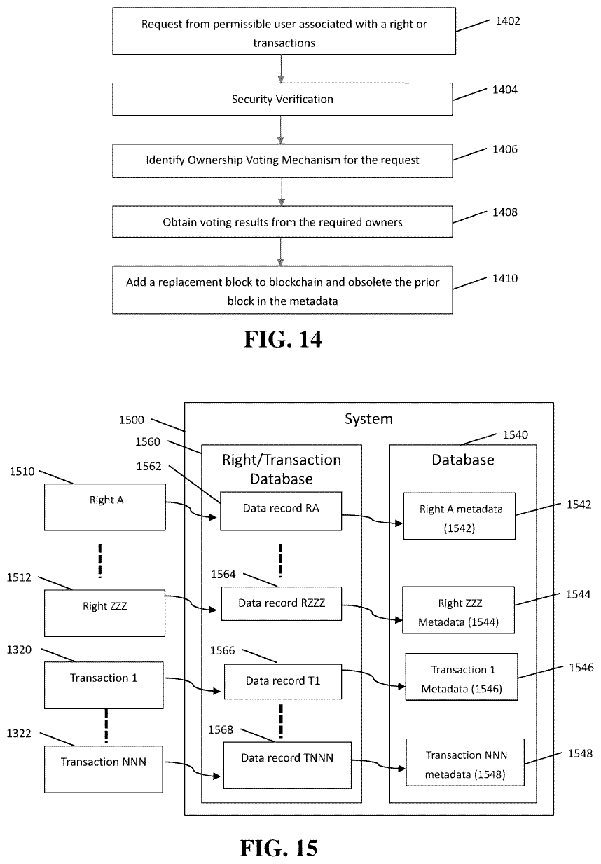

FIG. 14 depicts a flow chart for application of updating or nullifying a record according to some embodiments. Any changes to rights or transactions such as nullification or update of a collaboration are represented by new blocks with the chronically later blocks override the previous ones, and the earlier blocks will be marked as obsolete in the metadata. In FIG. 14, the method 1400 further comprises the steps of: receiving a request from permissible user associated with a right or transactions (1402); making security verification (1404); identifying ownership voting mechanism for the request (1406); obtaining voting results from the required owners (1408); and adding a replacement block to blockchain and obsolete the prior block in the metadata (1410).

FIG. 15 depicts a block diagram showing an example of a system implemented with relationship database according to some embodiments. Alternatively, the method or the system 1500 is adapted to use a relationship database to record the right information and transaction information as records in the database. The user interface and contents/permissions information will remain the same. Except in the method or the system 1500, user can modify the right information and transaction information without requiring to create a new record. Once an update or nullification is performed, the record will be permanently modified to contain the updated information. The method or the system 1500 in this manner is more efficient and less resource-consuming than the manner above but since the data is maintained in a central database which can be updated, is comparatively less secure and transparent.

According to some embodiments, a set of tools and rules is provided to perform essential operations such as user registrations, right information creations/removals, transaction information creations and nullifications, right search, etc. Additional commercial operations are provided to facilitate commercial transactions such as bidding, business contract templates, etc. Transaction requires additional user interface as to identify the rights (have to be in the system) being combined and the right being created. Such information is recorded in the metadata database as hierarchical data structures and can optionally be recorded in the transaction information and the resulting right information. The user has to complete the information on both the transaction information and the resulting right information before both of them are created at the same time.

A user starts by registering an account with the system and uses the account to meet his/her use case requirements. To facilitate these use cases, the method of the system provides a number of operations including:
User account registrations and shutdowns.
Creations/removal of public user information such as skillset, background, etc. to be displayed for potential collaborators, and private user information such as contact information, financial transaction information (e.g. bank account), etc. for privileged operations.
Allowing the products or user skillset to be searched via keyword, excerpts, categories, illustrations, etc.
Allowing users to create, update or nullify rights or transactions based on their products.
Securely and transparently storing right information and transaction information; and manage their accesses.
Allowing information on the products to be searched and displayed for integration/sale purpose.
Allowing users to interact with each other and/or with external parties (e.g. from external platforms) for potential project collaborations.
Providing certified owner information claim to permissible collaborative parties.
Generating and managing metadata associated with the rights and transactions to allow for efficient operations, and cross-references.
Integrations with other product development/sale/display platforms for sale/marketing/product information exchanges as well as commercial or legal transactions using a system generated token.
Additionally, letting commerce operation tools can be implemented to allow for commercial/legal transactions of rights by either internal or external parties such as biddings, marketing, sales, contract agreements, etc., based on right ID and/or system generated token. In which case the system serves as a third-party recordkeepers of official commercial/legal records
Additionally, letting entitlement collection and distribution can be performed either automatically or manually based on user requests where the system serves as a third-party escrow and process agent (FIG. 9)
Additionally, letting voting mechanism can be implemented based on the embedded right voting owner structure for any decisions required ownership voting (FIG. 10)
Additionally, letting legal operation tools can be implemented to allow for collecting necessary legal proof in a case of dispute, either internally or externally (FIG. 11); the system can provide certified proof as to the document dates, owners, authenticities, etc.

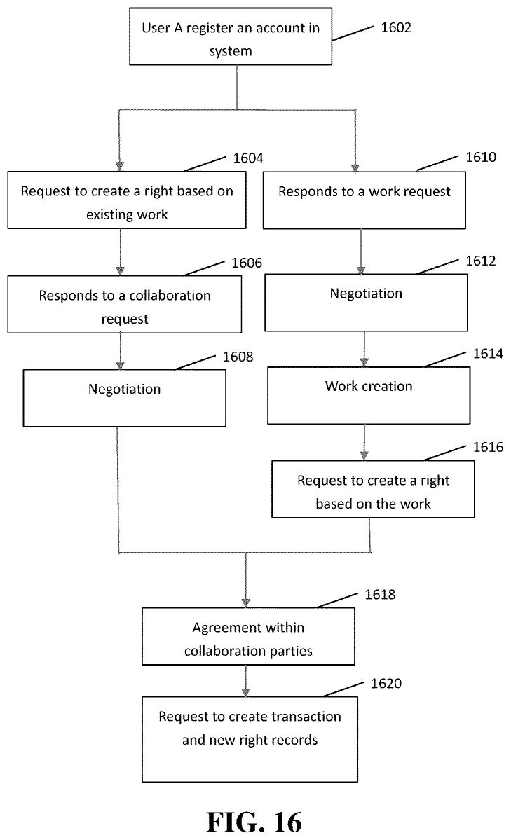

FIG. 16 depicts a flow chart of an operating example of the system according to some embodiments. In FIG. 16, user A registers an account in system (1602). Then user A can take steps of: sending a request to create a right based on existing work (1604); responding to a collaboration request (1606); negotiation (1608); responding to a work request (1610); having negotiation (1612); making work creation (1614); sending a request to create a right based on the work (1616); making agreement within collaborative parties (1618); and sending a request to create transaction and new right records (1620).

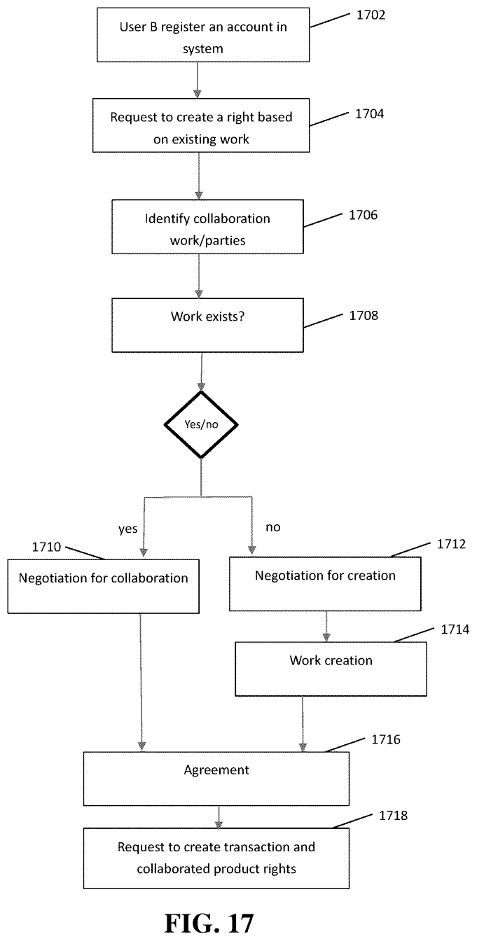

FIG. 17 depicts a flow chart of another operating example of the system according to some embodiments. In FIG. 16, user B registers an account in system (1702). Then user B can take steps of: sending a request to create a right based on existing work (1704); identifying collaborative work/parties (1706); confirming work existence (1708); having negotiation for collaboration (1710); having negotiation for creation (1712); making work creation (1714); making agreement (1716); and sending a request to create transaction and collaborated product rights (1718).

According to some embodiments, the steps in FIGS. 9-11 may be executed by a computerized process which uses smart contract tokens which are stored in the public block chains. The right information of the collaborative product is embedded in a smart contract token on a blockchain stored in public domain.

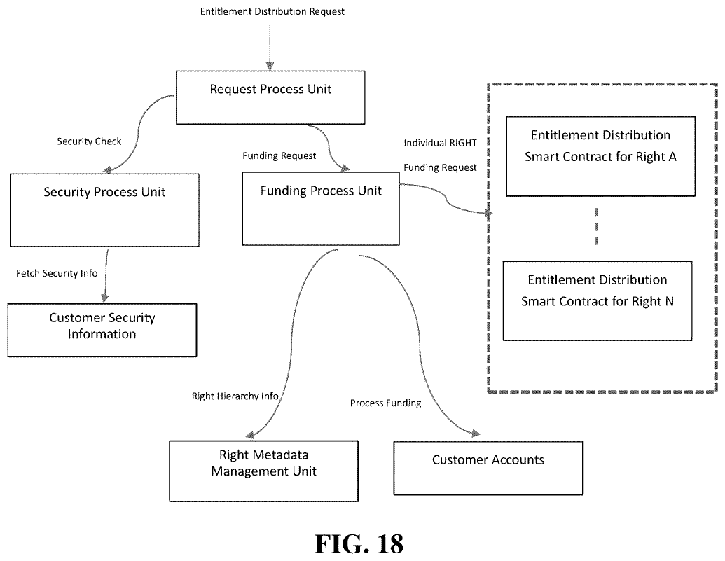

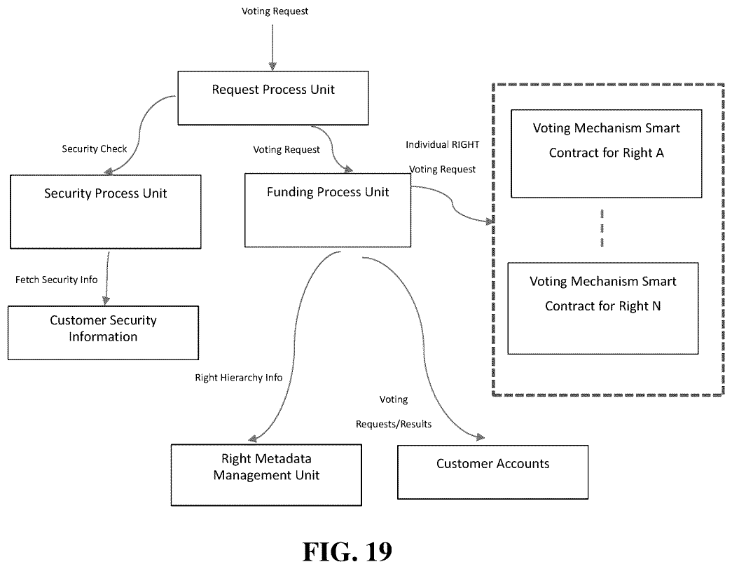

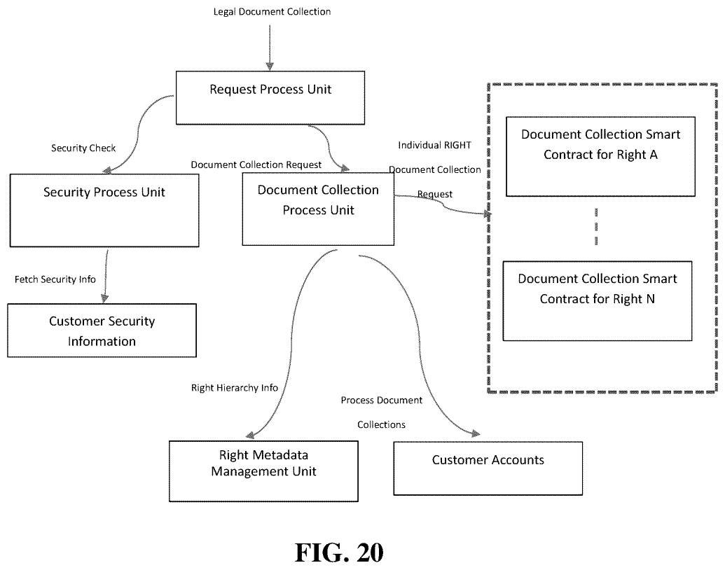

FIG. 18 depicts a block diagram showing an example of entitlement collection and distribution with smart contract according to some embodiments. FIG. 19 depicts a block diagram showing an example of voting mechanism with smart contract according to some embodiments. FIG. 20 depicts a block diagram showing an example of legal document collection with smart contract according to some embodiments.

According to some embodiments, smart contracts tokens (such as implemented in Ethereum platform, e.g. ERC721) are created based the programmable contents provided by users. In such an implementation, entitlement collection and distribution tables need to be provided in a format which can pass system integrity check (e.g. a math table which can be absolute numbers or a logic process which can contain combinations of percentage and absolute number distribution, with conditions, FIG. 18). The method may comprise: invoking entitlement distribution based on the smart contract token containing entitlement information recorded in the right information of the hierarchical collaborative products; and distributing entitlement to entitled parties' accounts according to the entitlement distribution.

In such an implementation, a voting ownership table is required for voting mechanism (simpler logic, such as a math table which sums up to 100%, FIG. 19). The method may comprise: invoking voting mechanism based on the smart contract token containing voter information recorded in the right information of the hierarchical collaborative products; sending voting requests to voters' accounts according to the voting mechanism; receiving voting results; and tabulating the voting results and posting them to relevant users.

In such an implementation, an exact list of references to the needed legal documents in the right/transaction hierarchal data structure is required for the legal document collection (FIG. 20). A right sale processes payments to the escrow account of right, based on right ID or system generated token for right. The method may comprise: identifying locations of legal documents according to the smart contract token containing the right information of the hierarchical collaborative products; collecting the legal documents by obtaining from the locations; and providing the legal documents to user account.

An alternative implementation is to create executable modules in the system (e.g. Perl scripts) to be executed at the times of user requests. These modules are then stored by the system in the central database rather than in the blockchain.

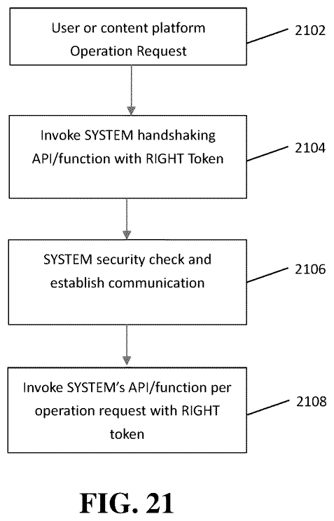

FIG. 21 depicts a flow chart of communication originated from content platform according to some embodiments. The content platform is a host platform for the collaborative product to be developed, displayed, shared or sold; based on the type of the product. To communicate seamless with such a platform, the method or the system works with the platform provider to integrate certain APIs/functions such as, but not limited to: sale, revenue collection, contracts, copyright inquiries, voting requirements, etc. To facilitate seamless and secured communication, the method or the system generates a unique token from the product right which can consist of, but not limited to: right ID, payment method, product description, operation handling instructions for sale/voting/legal document collections, etc. In the simplest implementation, a token can be an ID uniquely associated with a right and used by a content platform to process payment to the system.

In FIG. 21, the method 2100 comprises the steps of: sending a user or content platform operation request (2102); invoking system handshaking API/function with right token (2104); making system security check and establish communication (2106); and invoking system's API/function per operation request with right token (2108).

According to some embodiments, the method further comprises the steps of: integrating with a content platform via network by using a token containing the right information of the collaborative product and an operation instruction. The right information of the collaborative product is embedded in a blockchain stored in public domain, resulting in that the content platform directly perform an operation according to the operation instruction contained in the token. The integrating comprises: establishing a communication channel from the content platform by using the token; and executing, for the content platform, processing of a payment to a right escrow account.

For example, the content platform establishes a communication channel with the system by using a right token and then work with the system for execution such as processing of a payment to a right escrow account.

Alternatively, the content platform and the system can divide the operation tasks based on user/system/content platform preferences, information security, efficiencies, etc.

In the case of the blockchain/smart contract implementations of right and operation instructions, as they are stored in public domain; content platform can perform the operations directly once it has completed the security check, with only limited support from the system.

Overall, such a system and the implementation methods provide low-cost, secured, efficient, and transparent storages of legal and commercial information for collaborative work products; which both provide high deterrence for infringing parties as well as providing critical functions such as entitlement collection and distributions and voting mechanisms. The method or the system therefore provides a trusted community for open collaborated work to safely take place. The creation of such a system will definitely serve the interests of the collaborative creative work providers and the society as a whole.

What is claimed is:

1. A method for hierarchically managing collaborative products including at least one first inferior collaborative product in collaboration with a plurality of source owners respectively owning a plurality of source products, comprising:
receiving at least one first collaboration request for the first inferior collaborative product originated from the source products;
obtaining right information of the source products;
generating first transaction information in association with the first inferior collaborative product between the source owners and a collaborative user of the first inferior collaborative product;
creating a combination of a plurality of sets of right information of the first inferior collaborative product based on the right information of the source products and the first transaction information, wherein each set of the right information of the first inferior collaborative product reflects a right relationship between the collaborative user of the first inferior collaborative product and the corresponding one of the source owners; and
storing the combination of the sets of the right information of the first inferior collaborative product and the first transaction information; and

2. The method of claim 1, further comprising:
forming a hierarchical data structure of the collaborative products and the source produces by executing at least N time following steps of:
receiving at least one N+1th collaboration request for at least one N+1th inferior collaborative product of the collaborative products originated from the Nth inferior collaborative product;
obtaining right information of the Nth inferior collaborative product;
generating N+1th transaction information in association with the N+1th inferior collaborative product between an owner of the Nth inferior collaborative product and a collaborative user of the N+1th inferior collaborative product;
creating a combination of at least one set of right information of the N+1th inferior collaborative product based on the right information of the Nth inferior collaborative product and the N+1th transaction information, wherein each set of the right information of the N+1th inferior collaborative product reflects a right relationship between the collaborative user of the N+1th inferior collaborative product and the corresponding one of the owner of the Nth inferior collaborative product; and
storing the combination of the at least one set of the right information of the N+1th inferior collaborative product and the N+1th transaction information;
wherein N>=1, N is positive integer;
wherein the right relationships between the source owners and the collaborative user of the N+1th inferior collaborative product are recorded in or traceable by the right information of the N+1th inferior collaborative product.

3. The method of claim 1, wherein one of the collaborative products is at least one of source code, executable software module, hardware design, electronic design, mechanical design, multimedia creative work, story, book, and metaverse virtual goods.

4. The method of claim 1, wherein one of the collaboration requests is intended for a new product collaboration or represents a product of collaboration.

5. The method of claim 1, wherein the right information of the collaborative products and the right information of the source products describe commercial and legal property, and the commercial and legal property includes at least one of voting, ownership structure, entitlement allocation, proof of right ownership, commercial and/or legal transaction history of right, and right limitation,
wherein the right information of the collaborative products is in associated with commercial and legal rights of the source owner and the collaborative user involved in the collaboration of the source owner and the collaborative user for the collaborative product.

6. The method of claim 1, wherein the transaction information includes legal and supporting document regarding product collaboration, and the document includes at least one of commercial contract, agreed payment, future entitlement collection and distribution method, voting/ownership structure agreements, and void condition and limitation.

7. The method of claim 1, wherein the storing comprising:
storing the right information of one of the collaborative product and the transaction information without storing a product content of the one of the collaborative product.

8. The method of claim 1, further comprising:
creating metadata to be associated with the right information of the collaborative products or the transaction information,
wherein the metadata includes at least one of name, keyword, abstract, demo, full content, ownership structure, entitlement collection and distribution method, marketing and sale information, transaction history, and reference/link to other right of other source or collaborative products,
wherein the metadata are used for keyword search, technical and sale information display to intended collaborators, voting, entitlement collection and distribution, or collection of reference commercial and legal data for a commercial or legal event

9. The method of claim 8, further comprising:
storing the metadata in a relationship database system,
wherein the metadata are searchable data in the relationship database system.

10. The method of claim 1, wherein one of the collaborative users is one of the source owners.

11. The method of claim 2, further comprising:
accessing right information of at least associated one of the collaborative products by traveling associated nodes of the hierarchical data structure.

12. The method of claim 11, wherein in the hierarchical data structure, a node of one of the source products is a parent node having multiple child nodes of the first inferior collaborative products, and a node of one of the Nth inferior collaborative product is a parent node having multiple child nodes of the N+1th inferior collaborative products.

13. The method of claim 11, further comprising:
invoking entitlement distribution based on entitlement information recorded in the right information of the hierarchical collaborative products resulting from the accessing by the traveling associated nodes of the hierarchical data structure; and
distributing entitlement to entitled parties' accounts according to the entitlement distribution.

14. The method of claim 11, further comprising:
invoking voting mechanism based on voter information recorded in the right information of the hierarchical collaborative products resulting from the accessing by the traveling associated nodes of the hierarchical data structure;
sending voting requests to voters' accounts according to the voting mechanism;
receiving voting results; and
tabulating the voting results and posting them to relevant users.

15. The method of claim 11, further comprising:
identifying locations of legal documents according to the right information of the hierarchical collaborative products resulting from the accessing by the traveling associated nodes of the hierarchical data structure;
collecting the legal documents by obtaining from the locations; and
providing the legal documents to user account

16. The method of claim 1, wherein the storing comprises:
creating non-fungible blocks in a blockchain; and
embedding the right information of the collaborative product and the transaction information into the non-fungible blocks.

17. The method of claim 16, further comprising:
creating metadata to be associated with the right information of the collaborative product and the transaction information; and
updating the right information of the collaborative product and the transaction information, wherein the updating comprises:
creating new non-fungible blocks in the blockchain;
embedding new right information of the collaborative product and new transaction information into the new non-fungible blocks;
marking the metadata associated with the right information of the collaborative product and the transaction information as obsolete; and
creating metadata to be associated with the new right information of the collaborative product and the new transaction information.

18. The method of claim 1, further comprising:
integrating with a content platform via network by using a token containing the right information of the collaborative product and an operation instruction.

19. The method of claim 18, wherein the right information of the collaborative product is embedded in a blockchain stored in public domain, resulting in that the content platform directly perform an operation according to the operation instruction contained in the token.

20. The method of claim 18, wherein the integrating comprises:
establishing a communication channel from the content platform by using the token; and
processing, for the content platform, a payment to a right escrow account.

21. The method of claim 2, wherein the right information of the collaborative product is embedded in a smart contract token on a blockchain stored in public domain, the method further comprising:
invoking entitlement distribution based on the smart contract token containing entitlement information recorded in the right information of the hierarchical collaborative products resulting from accessing right information of at least associated one of the collaborative products by traveling associated nodes of the hierarchical data structure; and
distributing entitlement to entitled parties' accounts according to the entitlement distribution.

22. The method of claim 2, wherein the right information of the collaborative product is embedded in a smart contract token on a blockchain stored in public domain, the method further comprising:
invoking voting mechanism based on the smart contract token containing voter information recorded in the right information of the hierarchical collaborative products resulting from accessing right information of at least associated one of the collaborative products by traveling associated nodes of the hierarchical data structure;
sending voting requests to voters' accounts according to the voting mechanism;
receiving voting results; and
tabulating the voting results and posting them to relevant users.

23. The method of claim 2, wherein the right information of the collaborative product is embedded in a smart contract token on a blockchain stored in public domain, the method further comprising:
identifying locations of legal documents according to the smart contract token containing the right information of the hierarchical collaborative products resulting from accessing right information of at least associated one of the collaborative products by traveling associated nodes of the hierarchical data structure;
collecting the legal documents by obtaining from the locations; and
providing the legal documents to user account.

24. A system for hierarchically managing collaborative products including at least one first inferior collaborative product in collaboration with a plurality of source owners respectively owning a plurality of source products, comprising:
one or more processors; and
one or more computer-readable storage media having stored thereon computer-readable instructions executable by the one or more processors to cause the system to perform operations comprising:
receiving at least one first collaboration request for the first inferior collaborative product originated from the source products;
obtaining right information of the source products;
generating first transaction information in association with the first inferior collaborative product between the source owners and a collaborative user of the first inferior collaborative product;
creating a combination of a plurality of sets of right information of the first inferior collaborative product based on the right information of the source products and the first transaction information, wherein each set of the right information of the first inferior collaborative product reflects a right relationship between the collaborative user of the first inferior collaborative product and the corresponding one of the source owners; and
storing the combination of the sets of the right information of the first inferior collaborative product and the first transaction information.

25. A non-transitory computer-readable storage medium having stored thereon computer-readable instructions for hierarchically managing collaborative products including at least one first inferior collaborative product in collaboration with a plurality of source owners respectively owning a plurality of source products, wherein the computer-readable instructions are executable to cause a computer to perform operations comprising:
receiving at least one first collaboration request for the first inferior collaborative product originated from the source products;
obtaining right information of the source products;
generating first transaction information in association with the first inferior collaborative product between the source owners and a collaborative user of the first inferior collaborative product;
creating a combination of a plurality of sets of right information of the first inferior collaborative product based on the right information of the source products and the first transaction information, wherein each set of the right information of the first inferior collaborative product reflects a right relationship between the collaborative user of the first inferior collaborative product and the corresponding one of the source owners; and
storing the combination of the sets of the right information of the first inferior collaborative product and the first transaction information.
